(19) United States
(12) Patent Application Publication
(10) Pub. No.: US 2021/0385068 A1
(43) Pub. Date: Dec. 9, 2021

(54) BLOCKCHAIN BASED MANAGEMENT OF INFORMATION ON IMAGING CONSUMBALE USAGE

(71) Applicant: Hewlett-Packard Development Company, L.P., Spring, TX (US)

(72) Inventor: Seunghee OH, Seongnam-si (KR)

(21) Appl. No.: 17/285,213

(22) PCT Filed: May 2, 2019
(86) PCT No.: PCT/US2019/030316

§ 371 Date: Apr. 14, 2021

(30) Foreign Application Priority Data
Nov. 5, 2018 (KR) 10-2018-0134753

(51) Int. Cl. H04L 9/06; G06F 3/12; H04L 9/32

(52) U.S. Cl. CPC H04L 9/0643; G06F 3/1235; H04L 2209/38; G06F 3/1203; H04L 9/3239; G06F 3/1287

(57) ABSTRACT

An image forming device and a method of operating the image forming device are provided. The method of operating the image forming device includes performing a first image forming job in the image forming device, generating at least one piece of transaction information including consumption information of at least one consumable in the image forming device, in accordance with the first image forming job, and, based on a network of a block chain that distributes and manages ledgers on which consumption information of consumables in a plurality of image forming devices is recorded, transmitting the at least one piece of transaction information to a plurality of nodes having the ledgers.

### BACKGROUND

Information regarding the consumption of a consumable in an image forming device is necessary when considering maintenance of the image forming device. The information regarding the consumption of the consumable in the image forming device may be stored and managed in the image forming device. Further, the information regarding the consumption of the consumable in the image forming device may be stored in a server. In this case, a manager of the image forming device may connect to the server and check the information regarding the consumable consumption.

### BRIEF DESCRIPTION OF DRAWINGS

Certain examples of the present disclosure will be more apparent from the following description taken in conjunction with the accompanying drawings, in which:

FIG. 1 is a conceptual diagram for explaining an operation with respect to a plurality of nodes for managing consumable consumption information according to an image forming job, based on a block chain, according to an example.

FIG. 2 is a flowchart of a method of operating an image forming device, according to an example.

FIG. 3 is a flowchart of a method of operating a plurality of nodes, according to an example.

FIG. 4 is a view for explaining a process of transmitting transaction information including consumable consumption information in a certain node to another node, according to an example.

FIG. 5 is a view for explaining a process of verifying the validity of transaction information in a certain node and generating a block, according to an example.

FIG. 6 is a view for explaining a process of verifying the validity of transaction information in a certain node, according to an example.

FIG. 7 is a view of a structure of blocks, in which transaction information including consumable consumption information is recorded, and a block chain, in which the blocks are concatenated to each other, according to an example.

FIG. 8 is a flowchart illustrating a process of verifying consumable consumption at a node, based on a block chain, according to an example.

FIG. 9 is a flowchart illustrating a process of generating a write block that manages only consumption information of a consumable held by a certain node at the certain node, according to an example.

FIG. 10 is a view of a structure of a write block and a write block chain, according to an example.

FIG. 11 is a block diagram of a configuration of an image forming device, according to an example.

Throughout the drawings, it should be noted that like reference numbers are used to depict the same or similar elements, features, parts, components, and structures.

### DETAILED DESCRIPTION OF EXAMPLES

An “image forming device” may be any device capable of performing an image forming job, such as a printer, a copier, a scanner, a fax machine, a multi-function printer (MFP), or a display device. The “image forming job” may be at least one of printing, copying, scanning, or faxing.

A “consumable” may be a certain part of the image forming device which is expended, worn out, shrunk, faded, etc. based on its use. For example, the “consumable” may be a toner cartridge, an organic photo conductor (OPC) drum, a roller, or the like.

A “block chain” refers to a distributed peer-to-peer (P2P) system of a ledger that utilizes software elements configured with an algorithm in which blocks are concatenated in an order using encryption and security technologies of transaction information to ensure and maintain integrity. In addition, “block chain” may refer to a distributed ledger technology in which a ledger that records transaction information is distributed to a P2P network instead of a central server of a specific organization, and nodes in the P2P network collectively record and manage the transaction information.

A “node” may refer to a component in the network of the block chain. For example, the node may be an image forming device, a network attached storage (NAS), a server, or the like.

Below, a description will be given about examples of the present disclosure with reference to attached drawings such that one with an ordinary skill in the art may easily perform examples. In this regard, the present disclosure may have different forms and should not be construed as being limited to the descriptions set forth herein.

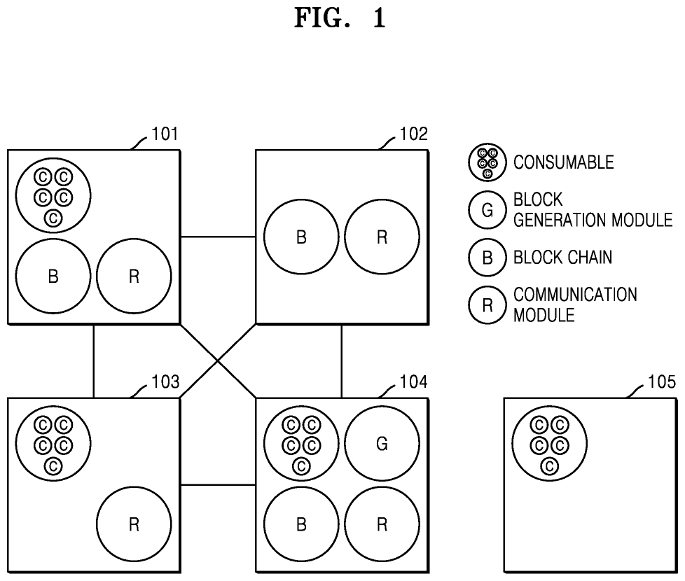

FIG. 1 is a conceptual diagram for explaining an operation with respect to a plurality of nodes for managing consumable consumption information according to an image forming job, based on a block chain, according to an example.

Referring to FIG. 1, a plurality of nodes 101, 102, 103, and 104 may share and store consumable consumption information based on the block chain. The plurality of nodes 101, 102, 103, and 104 may be one of an image forming device, an NAS, a server, or the like. The image forming device may include at least one consumable and may further include at least one of a block generation module, a block chain, and a communication module according to a performance of the image forming device.

For example, as shown in FIG. 1, the first node 101 may be an image forming device including a consumable, a block chain, and a communication module. The second node 102 may be an NAS including a block chain and a communication module. The third node 103 may be an image forming device including a consumable and a communication module. The fourth node 104 may be an image forming device including a consumable, a block generation module, a block chain, and a communication module. A fifth node 105 may be an image forming device including a consumable. The first node 101, the second node 102, the third node 103, and the fourth node 104 are unit nodes connected to a network of the block chain. The fifth node 105 is not a unit node connected to the network of the block chain because the fifth node 105 is an image forming device including only a consumable.

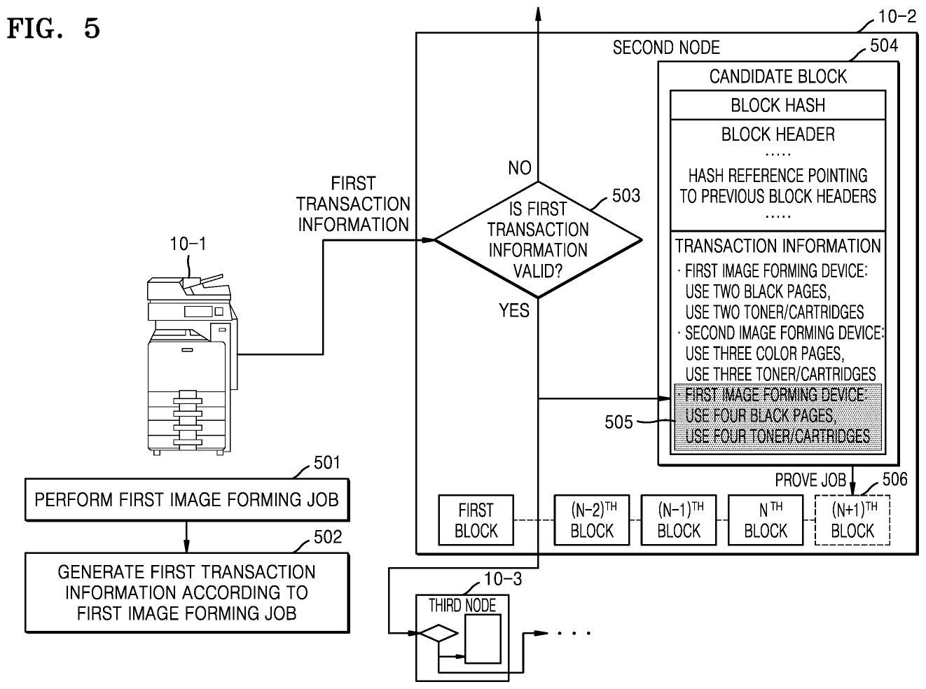

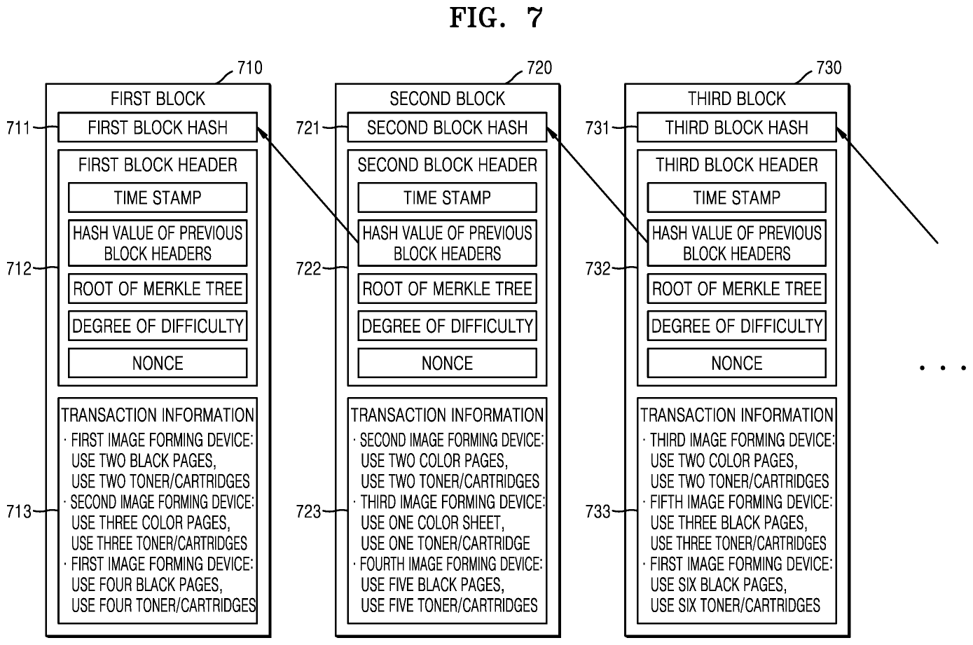

The block generation module may generate a block including consumption information of a consumable. The generated block is shared by the nodes having the block chain through the communication module. The nodes sharing the block may verify validity of the block and add the verified block to the block chain. Thus, the block chain may substantially store and manage consumption information of a consumable. An example of generating the block will be described in FIG. 5, and an example of a structure of the block and the block chain will be described in FIG. 7.

The communication module may have internet protocol (IP) information (e.g., an IP address) of a node to be connected first to the network for P2P communication among nodes. The IP address of the node to be connected first may be set in the communication module or may be set according to the input of a manager. In addition, the communication module may transmit a broadcast packet to the network of the block chain and register another node in response to the broadcast packet. Furthermore, the communication module may register an unregistered node by sharing a list of registered nodes among the nodes.

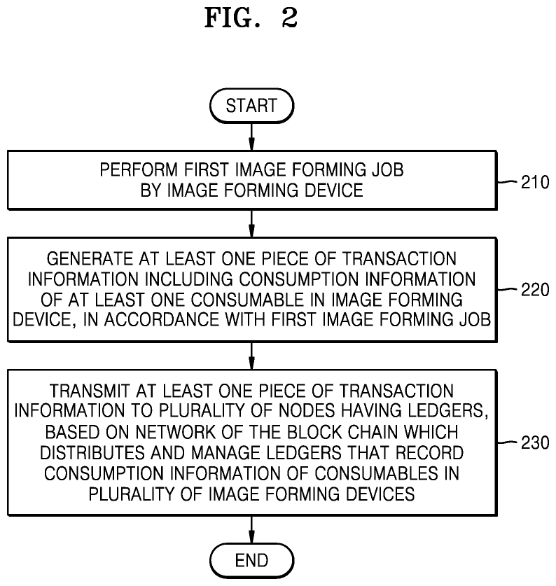

FIG. 2 is a flowchart of a method of operating an image forming device, according to an example.

Referring to FIG. 2, an image forming device may perform a first image forming job in operation 210. In an example, a processor in the image forming device may perform the first image forming job by controlling at least one configuration or unit used for performing the first image forming job. For example, when the first image forming job is a print job, the processor in the image forming device may perform a certain image forming job by controlling a printing unit in the image forming device. As another example, when the first image forming job is a copying job, the processor in the image forming device may perform a certain image forming job by controlling a copying unit in the image forming device.

In operation 220, the image forming device may generate at least one piece of transaction information including consumption information of at least one consumable in the image forming device, in accordance with the first image forming job.

For example, the consumable may be a toner cartridge, an OPC drum, a roller, or the like. A private key and a public key for the consumable may be used by the image forming device to generate the transaction information including the consumable consumption information.

In an example, the private key and the public key for the consumable may be generated at the time when the consumable is produced or at the time when the consumable is mounted in the image forming device. For example, when a first consumable is mounted in the image forming device, the image forming device may confirm whether the first private key and the first public key for the first consumable are stored in an internal storage of the first consumable. When the first private key and the first public key are not stored in the internal storage of the first consumable, the image forming device may generate the first private key and the first public key for the first consumable.

The private key and the public key for the consumable may be stored in the internal storage of the consumable or stored in a memory of the image forming device.

For example, the image forming device may obtain first consumption information of the first consumable in the image forming device according to the first image forming job. The image forming device may obtain first identification information indicating the first consumable and generate first transaction information encrypted with the first consumption information. The first identification information may be eigenvalue information of the first consumable. In an example, the first transaction information may further include information for tracking use of the first consumable, such as the name of the first consumable, the name of the image forming device equipped with the first consumable, and the like. The first consumption information may include information indicating consumption of the first consumable according to the first image forming job and may be stored as the number of output pages, dot count information of the output, and the like. Also, the first consumption information may be stored as a value of a certain parameter that is a reference for measuring consumption of the first consumable. For example, the certain parameter may be a driving amount such as the number of revolutions of parts related to the first consumable.

When a processor is included in the first consumable, the processor in the first consumable may obtain the first consumption information of the first consumable according to execution of the first image forming job and may generate the first transaction information. The processor of the first consumable may provide the generated first transaction information to the processor or the memory of the image forming device.

When a processor is not included in the first consumable, the image forming device may obtain the first consumption information of the first consumable according to execution of the first image forming job and may generate the first transaction information. For example, when the first consumable is a roller and the first image forming job is to print three pages, the image forming device may determine the number of revolutions of the roller for printing three pages and obtain the number of revolutions of the roller as roller consumption information. The image forming device may generate transaction information including roller identification information and the roller consumption information.

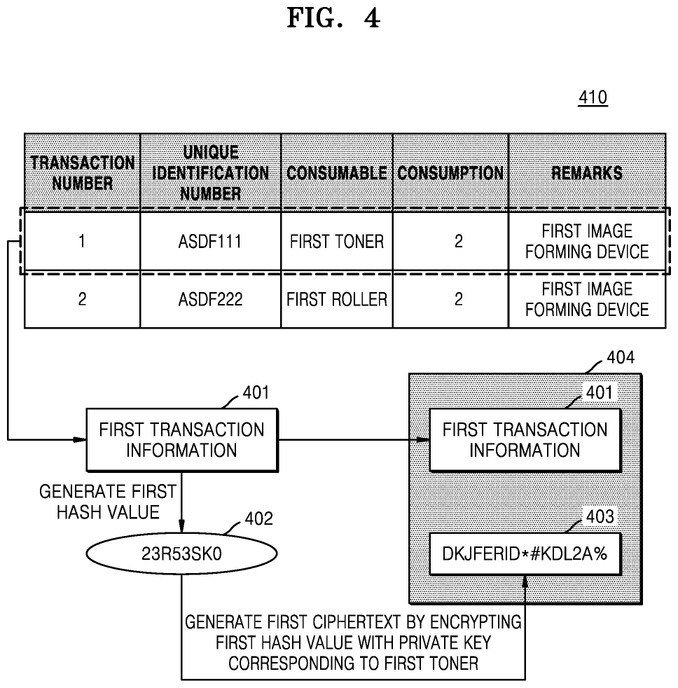

In an example, the image forming device may generate a first hash value by applying information including first identification information and the first consumption information to a hash function. The hash function is a function for generating unique data when certain data is input. The image forming device may encrypt the first hash value with a private key corresponding to the first consumable to generate a digitally signed first ciphertext. An example of generating encrypted transaction information will be described below with reference to FIG. 4.

In operation 230, the image forming device may transmit at least one piece of transaction information to a plurality of nodes having ledgers, based on a network of the block chain. The network of the block chain may be a network configured to distribute and manage the ledgers that record consumption information of consumables in a plurality of image forming devices.

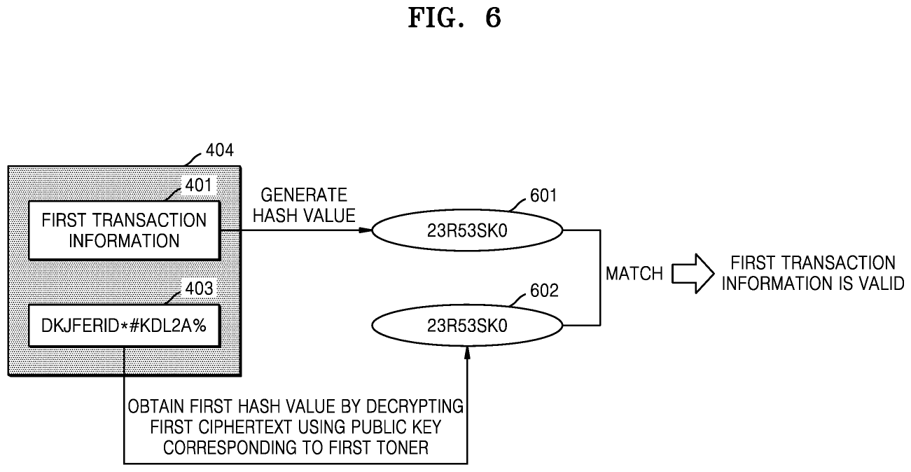

For example, the image forming device may transmit the first transaction information including the first consumption information of the first consumable in the image forming device to a plurality of nodes. The plurality of nodes receiving the first transaction information may verify validity of the first transaction information and generate a block including the first transaction information. The generated block may be added to the block chain. An example of verifying the validity of the transaction information will be described below with reference to FIG. 6.

In another example, the image forming device may transmit a block in which the first transaction information is recorded to a plurality of nodes. In an example, the image forming device may record the first transaction information in a candidate block. When a certain number or more of pieces of transaction information are recorded in the candidate block, the image forming device may prove a job of the candidate block and add the candidate block to the block chain of the image forming device as a valid first block. The image forming device may transmit the first block to a plurality of nodes. An example of the block and the block chain will be described below with reference to FIG. 7.

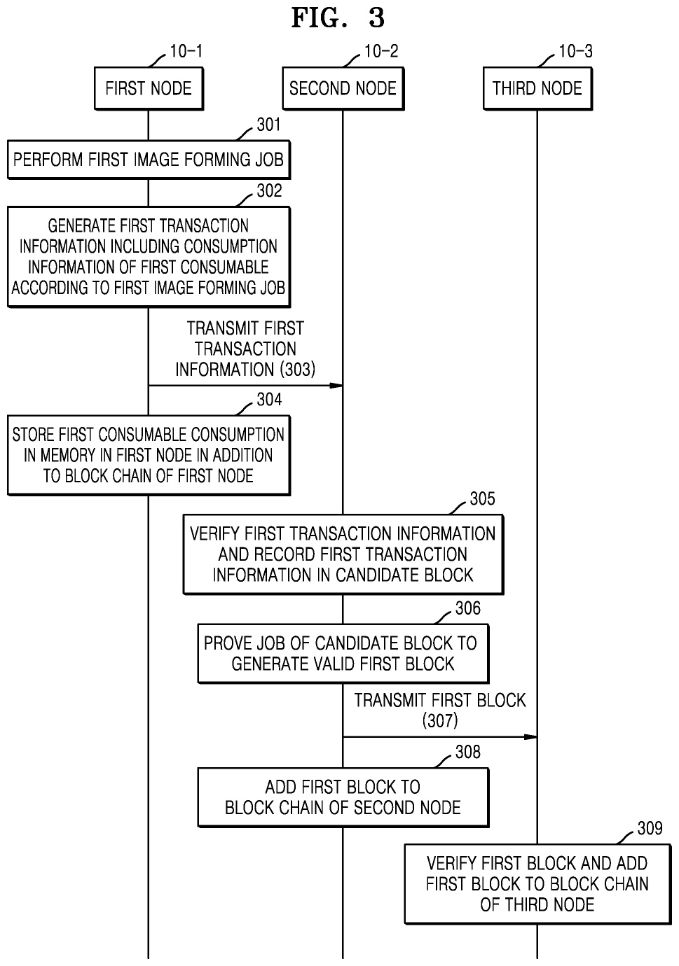

FIG. 3 is a flowchart of a method of operating a plurality of nodes, according to an example.

Referring to FIG. 3, the nodes may include at least one of an image forming device, an NAS, a server, or the like.

In operation 301, a first node 10-1 may perform a first image forming job. In operation 302, the first node 10-1 may generate first transaction information including consumption information about a first consumable according to the first image forming job.

In operation 303, the first node 10-1 may transmit the first transaction information to a second node 10-2. In operation 304, the first node 10-1 may store first consumable consumption in a memory in the first node 10-1 in addition to a block chain of the first node 10-1.

In operation 305, the second node 10-2 may verify the first transaction information and record the first transaction information in a candidate block.

In operation 306, the second node 10-2 may prove a job of the candidate block to generate a valid first block.

In operation 307, the second node 10-2 may transmit the first block to a third node 10-3.

In operation 308, the second node 10-2 may add the first block to a block chain of the second node 10-2.

In operation 309, the third node 10-3 may verify the first block and add the first block to a block chain of the third node 10-3.

FIG. 4 is a view for explaining a process of transmitting transaction information including consumable consumption information in a certain node to another node, according to an example.

Referring to FIG. 4, a first node may generate transaction information including consumption information of a first toner and a first roller in accordance with the execution of a first image forming job. For example, the first node may be an image forming device, and the first image forming job may be a job for printing two pages. As illustrated in table 410, the transaction information may include at least one of a unique identification number of a consumable, the type of the consumable, consumption, and information of an image forming device equipped with the consumable. The information of the image forming device may include a unique identification number, a type, a model of the image forming device, or the like. For example, first transaction information may include information indicating that a first toner is used in the job for printing two pages in the first image forming device. The first toner may be distinguished by a unique identification number ASDF111 corresponding to the first toner. The consumption information may be stored as a value of a certain parameter that is a reference for measuring consumable consumption. For example, the certain parameter may be the number of revolutions of parts related to the consumable. Second transaction information may be information indicating that the first roller in the first image forming device is used in the job for printing two pages. The first roller may be distinguished by a unique identification number ASDF222 corresponding to the first roller.

The transaction information including consumable consumption information may be encrypted and transmitted to a plurality of nodes. A private key and a public key corresponding to the consumable may be allocated to the consumable. The private key and the public key are composed of a pair, and the transaction information encrypted with the private key may be decrypted with the public key. Also, the transaction information encrypted with the public key may be decrypted with the private key. The public key may be used for verifying the transaction information including consumable consumption information. The public key may also have a one-to-one relationship with the unique identification number of the consumable.

The first node may transmit the transaction information to a second node. For example, a process in which the first node transmits first transaction information to the second node will be described.

As illustrated in FIG. 4, the first node may apply first transaction information 401 to a hash function to generate a first hash value 402, “23R53SK0”. The first node may generate a first ciphertext 403, “DKJFERID*#KDL2A%”, by encrypting the first hash value 402 with a private key corresponding to the first toner. The first node may transmit the first ciphertext 403 to the second node 404. Also, the first node may transmit the first ciphertext 403 and the first transaction information 401 to the second node 404.

FIG. 5 is a view for explaining a process of verifying the validity of transaction information in a certain node and generating a block, according to an example.

Referring to FIG. 5, the first node 10-1 may perform a first image forming job in operation 501. In operation 502, the first node 10-1 may generate first transaction information according to the first image forming job. The first node 10-1 may transmit the first transaction information to the second node 10-2. Since the operation of transmitting the first transaction information from the first node 10-1 to the second node 10-2 is substantially the same as the operation of the first node 10-1 described with reference to FIG. 4, repeated descriptions thereof will not be given herein.

In operation 503, the second node 10-2 may decrypt encrypted first transaction information and verify whether or not the first transaction information is valid based on a result of the decryption. An example of verifying of the validity of the first transaction information will be described below with reference to FIG. 6.

As a result of verifying the validity of the first transaction information, when the first transaction information is invalid, the second node 10-2 may discard the first transaction information.

As a result of verifying the validity of the first transaction information, when the information of the first transaction is valid, the second node 10-2 may transmit the first transaction information to a plurality of nodes (e.g., the third node 10-3). In addition, the second node 10-2 may record the first transaction information 505 in a candidate block 504. When a certain number or more of pieces of transaction information are recorded in the candidate block 504, the second node 10-2 may generate a valid block by proving a job of the candidate block 504. The second node 10-2 may add the valid block to a block chain of the second node 10-2 as an (N+1)^{th} block 506. In addition, the second node 10-2 may transmit the valid block to the plurality of nodes. An example of generating the block is described below with reference to FIG. 7.

The third node 10-3 may verify the validity of the first transaction information by receiving the first transaction information from the second node 10-2. In addition, the third node 10-3 may generate a valid block including the first transaction information and add the valid block to a block chain of the third node 10-3.

Furthermore, the third node 10-3 may receive a block including the first transaction information from another node and may verify validity of the block to add a valid block to the block chain of the third node 10-3. In an example, the third node 10-3 may verify the validity of a block by comparing a hash value of encrypted transaction information in the block and a hash value of the transaction information. Also, when the block includes a public key corresponding to a node, the third node 10-3 may verify validity of the block by confirming whether or not the public key corresponds to an authenticated node.

FIG. 6 is a view for explaining a process of verifying the validity of transaction information in a certain node, according to an example.

As described in FIGS. 4 and 5, the second node 404 may receive the first transaction information 401 and the first ciphertext 403 encrypted with the first transaction information 401 from the first node. Referring to FIG. 6, the second node may obtain a hash value 601, “23R53SK0”, corresponding to the first transaction information 401 by applying a hash function to the first transaction information 401. Also, the second node may obtain a hash value 602, “23R53SK0”, by decrypting the first ciphertext 403, “DKJFERID*#KDL2A%”, using a public key corresponding to a first toner. Since the hash value 601 of “23R53SK0” matches the hash value 602 of “23R53SK0”, the second node may determine that the first transaction information 401 received from the first node is valid. The second node may add the first transaction information 401 determined to be valid to a transaction information list in a candidate block. When a certain number or more of pieces of transaction information are recorded in the transaction information list, the second node may generate a valid block by proving a job of the candidate block.

In an example, when a hash value obtained by applying a hash function to the first transaction information 401 is different from a hash value obtained by decrypting the first ciphertext 403 using a public key corresponding to the first toner, the second node may determine that the first transaction information 401 received from the first node is invalid. The second node may discard the first transaction information 401 that is determined to be invalid.

FIG. 7 is a view of a structure of blocks, in which transaction information including consumable consumption information is recorded, and a block chain, in which the blocks are concatenated to each other, according to an example.

Referring to FIG. 7, the block chain may be configured by concatenating blocks that record valid transaction information. A data structure of the block chain may be a certain data structure composed of units in which the blocks recording the transaction information are arranged in an order. In addition, the data structure of the block chain may include a data structure in which block headers are concatenated to each other in a chain format with reference to previous block headers, respectively, and a data structure of a Merkle tree in which a hash reference pointing to data of the transaction information and the data of the transaction information are connected to each other in a tree format.

The blocks may include a block hash, a block header, transaction information, and so on. The block header may include a time stamp, a hash value of the previous block headers, a root of the Merkle tree, the degree of difficulty, and information about a nonce. As illustrated in FIG. 7, a block chain of a certain node may be connected to a first block 710, a second block 720, and a third block 730. Each of the blocks 710, 720, and 730 may include block hashes 711, 721, and 731, block headers 712, 722, and 732, and transaction information 713, 723, and 733.

The block hash may be a hash value of a hash function applied with the time stamp, the hash value of the previous block headers, the root of the Merkle tree, the degree of difficulty, and the information about a nonce as input values. That is, the value of the block hash may be a value obtained by hashing a block header, not a value obtained by hashing the entire block.

A hash value of a previous block header uniquely identifies each block header and may be used to reference the previous block header. When each block header refers to the previous block header, an order of individual block headers and blocks may be maintained. As illustrated in FIG. 7, since the first block 710 is a first block and there is no previous block, there is no reference to the previous block header. Thus, the hash value of the previous block header of the first block 710 is zero. Since the second block 720 has the first block 710 as the previous block, a hash value of a previous block header of the second block 720 is a first block hash 711 of a first block header 712. Since the third block 730 has the second block 720 as the previous block, a hash value of a previous block header of the third block 730 is a second block hash 721 of a second block header 722.

The Merkle tree may refer to a structure in which the hash reference and the data of the transaction information are connected to each other in a tree format. The hash reference may refer to the data of the transaction information using an encrypted hash value. Since the encrypted hash value is a unique value of data, different pieces of data do not have an identical hash value.

The time stamp may refer to a time when a node started to prove the job. The degree of difficulty may refer to a constraint in the proof of the job or a hash puzzle. Nonce may refer to a value that is adjusted such that the value of the block hash satisfies the constraint for the proof of the job.

For example, a process in which the first node, having the block chain including the first block 710 and the second block 720, generates the third block 730 to be added to the block chain at the first node will be described. The first node may determine a route of the Merkle tree for transaction information 733. The first node may generate a hash reference pointing to a previous block header in the context of the third block 730 to be added to the block chain. The first node may obtain the degree of difficulty required for the proof of a job or constraint of the third block 730 to be added to the block chain. The first node may confirm whether a value of the block hash satisfies the constraint by applying a hash function to the root of the Merkle tree, the hash reference pointing to the previous block header, the degree of difficulty, data of the time stamp, and the nonce. For example, the first node may obtain a value of the nonce that satisfies the constraint while increasing the nonce from 0 to 1 and prove the job for a candidate block. The first node may add the candidate block to the block chain as the valid third block 730. The first node may transmit the third block 730 to other nodes on a network of the block chain.

When the first node has a long, time-consuming performance to generate blocks, it may facilitate the generation of blocks by lowering the degree of difficulty or sharing a public key corresponding to a block of another authenticated node.

The second node may receive the third block 730 from the first node. The second node may verify validity of the third block 730 and add the third block 730 to a block chain of the second node.

Furthermore, when a plurality of blocks having the second block 720 as the previous block are received at the second node, the second node may select only one of the plurality of blocks as a block having the second block 720 as the previous block according to a certain criterion. For example, the certain criterion may be a criterion in which a block generated at the most nodes within a certain period of time is selected. The certain criterion may be a criterion on which a block having a shared key corresponding to the authenticated node is selected.

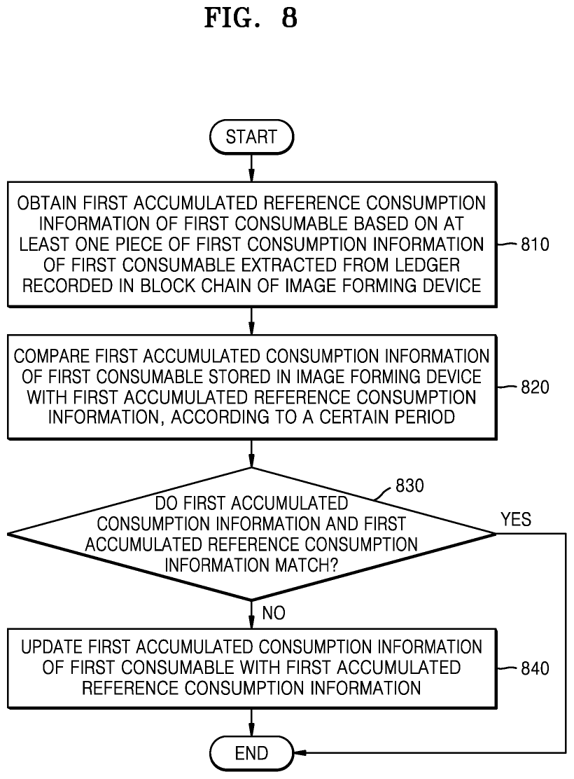

FIG. 8 is a flowchart illustrating a process of verifying consumable consumption at a certain node, based on a block chain, according to an example.

Referring to FIG. 8, the certain node may periodically verify the consumable consumption at the certain node based on the block chain. The certain node may verify the consumable consumption by comparing accumulated consumption of a consumable stored in the certain node with accumulated consumption of a consumable recorded in a block chain of the certain node. FIG. 8 describes an image forming device as an example of the certain node.

In operation 810, the image forming device may obtain first accumulated reference consumption information about a first consumable based on a ledger recorded in a block chain of the image forming device. In an example, the image forming device may extract at least one piece of first consumption information of the first consumable from the ledger recorded in the block chain. The image forming device may obtain the first accumulated reference consumption information of the first consumable by summing at least one piece of first consumption information of the first consumable.

Taking FIG. 7 as an example, a first image forming device may obtain accumulated reference consumption information of a toner cartridge based on a ledger recorded in a block chain of the first image forming device. In an example, the first image forming device may obtain consumption information from the first block 710 indicating that the amount corresponding to 2+4=6 pages has been used for the toner cartridge. Furthermore, the first image forming device may obtain consumption information from the third block 730 indicating that the amount corresponding to 6 pages has been used for the toner cartridge. That is, the first image forming device may extract the consumption information of the toner cartridge in each block and add the extracted consumption information to obtain accumulated reference consumption information indicating that the amount corresponding to 12 pages has been used for the toner cartridge.

In operation 820, the image forming device may compare first accumulated consumption information of the first consumable stored in the image forming device with the first accumulated reference consumption information, according to a certain period. The first accumulated consumption information of the first consumable may be updated each time the first consumable is used.

In operation 830, the image forming device may determine whether the first accumulated consumption information and the first accumulated reference consumption information match.

When the first accumulated consumption information matches the first accumulated reference consumption information, the image forming device may confirm integrity of the first accumulated reference consumption information and end the process. For example, when accumulated reference consumption information of the toner cartridge in the first image forming device is 12 pages and the accumulated consumption information is also 12 pages, the image forming device may confirm integrity of the accumulated consumption information.

When the first accumulated consumption information and the first accumulated reference consumption information do not match with each other, the image forming device may perform operations according to operation 840.

In operation 840, the image forming device may update the first accumulated consumption information of the first consumable with the first accumulated reference consumption information. Since the first accumulated reference consumption information is obtained from consumption information of the first consumable recorded in the block chain, integrity of the first accumulated reference consumption information may be guaranteed. Therefore, the image forming device may correct the first accumulated consumption information of the first consumable to the first accumulated reference consumption information. For example, when the accumulated reference consumption information of the toner cartridge in the first image forming device is 12 pages and the accumulated consumption information is 10 pages, the image forming device may correct the accumulated reference consumption information of the toner cartridge to 12 pages.

When the first consumable in the image forming device is replaced with a second consumable which is same as the first consumable, the image forming device may obtain second accumulated reference consumption information of the second consumable based on the network of the block chain. For example, when the second consumable has been installed in another image forming device, the image forming device may obtain transaction information including consumption information of the second consumable based on the network of the block chain. The image forming device may obtain the second accumulated reference consumption information of the second consumable based on the transaction information including the consumption information of the second consumable. The image forming device may update the second accumulated consumption information of the second consumable with the second accumulated reference consumption information.

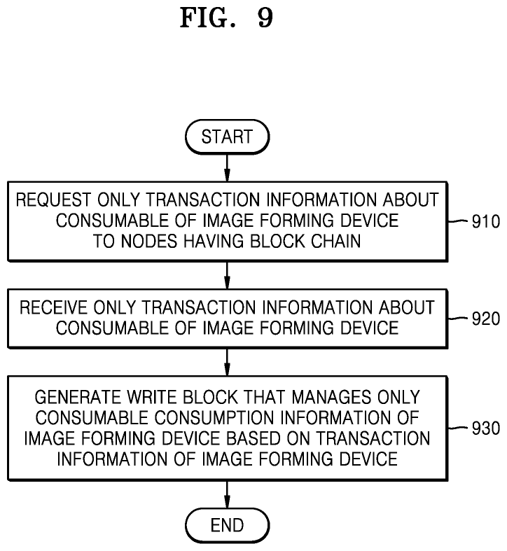

FIG. 9 is a flowchart illustrating a process of generating a write block that manages only consumption information of a consumable held by a certain node at the certain node, according to an example.

Referring to FIG. 9, the certain node may record transaction information including only the consumption information of the consumable held by the certain node without recording transaction information including consumption information of a consumable held by the other node in a block chain of the certain node and may manage consumable consumption information. In this case, the block chain held by the certain node may be referred to as a write block chain, and a block held by the certain node may be referred to as a write block. FIG. 9 describes an image forming device as an example of the certain node.

In operation 910, the image forming device may request only transaction information about a consumable of the image forming device to nodes having the block chain. In this case, the image forming device may transmit a public key or an identification number corresponding to the image forming device to the nodes. Each of the nodes may extract only transaction information about the image forming device at the request of the image forming device.

In operation 920, the image forming device may receive only the transaction information about the consumable of the image forming device from the nodes.

In operation 930, the image forming device may generate a write block that manages only consumable consumption information of the image forming device. Further, the image forming device may add the write block to a write block chain.

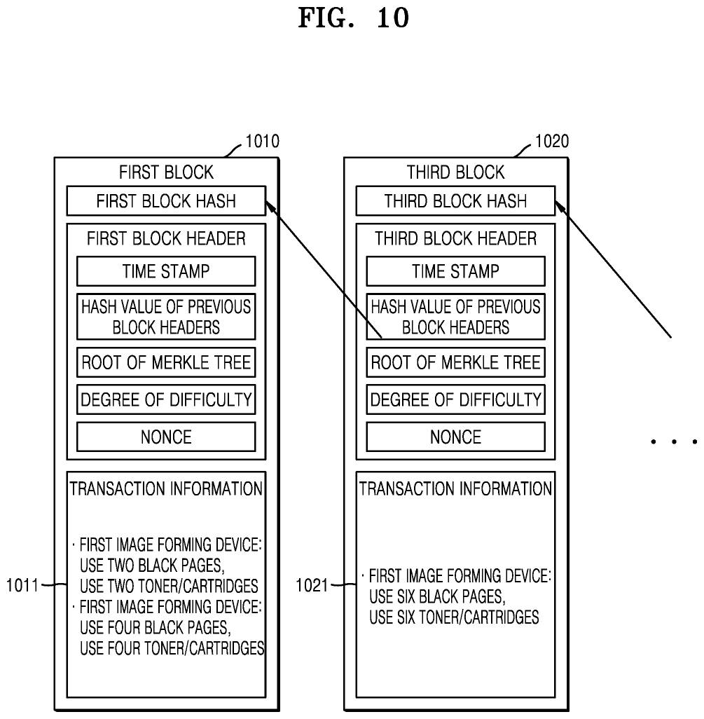

FIG. 10 is a view of a structure of a write block and a write block chain, according to an example.

Referring to FIG. 10, the image forming device may receive only transaction information about a consumable of the image forming device from a plurality of nodes. The image forming device may generate at least one write block recording only the transaction information about a consumable of the image forming device and add at least one write block to the write block chain.

Taking FIGS. 7 and 10 as an example, a first image forming device may generate at least one write block recording only transaction information about a consumable of the first image forming device and add the write block to the write block chain. As shown in FIG. 10, the write block chain may include a first block 1010 and a third block 1020. The first block 1010 may record only transaction information 1011 about the consumable of the first image forming device. Also, the third block 1020 may record only transaction information 1021 about the consumable of the first image forming device.

Since a structure of the write block and the write block chain shown in FIG. 10 is substantially the same as a structure of the block and block chain shown in FIG. 7, repeated descriptions thereof will not be given herein.

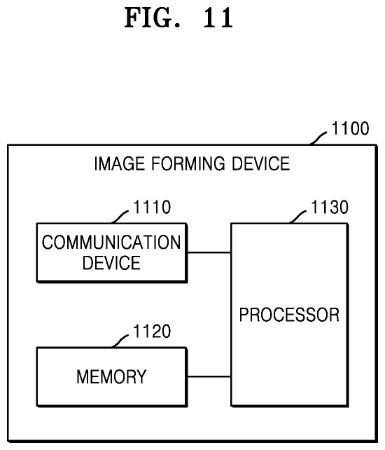

FIG. 11 is a block diagram of a configuration of an image forming device, according to an example.

Referring to FIG. 11, the image forming device 1100 may include a communication device 1110, a memory 1120, and a processor 1130. The image forming device 1100 may be embodied with more or fewer elements than the elements shown in the drawings. Hereinafter, the elements will be described.

The communication device 1110 may communicate with an external device. In an example, the communication device 1110 may be connected to a network in a wired or wireless manner and may communicate with the external device. The external device may be a node that distributes and manages a ledger based on a block chain.

The communication device 1110 may include a communication module (e.g., a transceiver) that supports one of a variety of wired or wireless communication methods. For example, the communication module may be in the form of a chipset or may be a sticker/barcode (e.g., a sticker including a near field communication (NFC) tag) or the like that includes information necessary for communication. The communication module may be a short-range communication module or a wired communication module.

The communication device 1110 may support at least one of, for example, a wireless local area network (LAN), wireless fidelity (Wi-Fi), Wi-Fi Direct, Bluetooth, a universal serial bus (USB), a Wired LAN, NFC, or the like.

The memory 1120 may store programs, data, or files associated with the image forming device 1100. For example, the processor 1130 may execute a program stored in the memory 1120, read data or a file stored in the memory 1120, or store a new file in the memory 1120. The memory 1120 may store program commands, data files, data structures, or a combination thereof. The memory 1120 may store instructions executable by the processor 1130.

For example, the memory 1120 may store instructions for performing a first image forming job in the image forming device 1100, instructions for generating at least one piece of transaction information including consumption information of at least one consumable in the image forming device 1100, in accordance with the first image forming job, and instructions that transmit at least one piece of transaction information to a plurality of nodes having a ledger based on a network of a block chain that distributes and manages the ledger on which consumption information of consumables in a plurality of image forming devices 1100 is recorded.

The processor 1130 controls overall operations of the image forming device 1100, and may include at least one processor, such as a central processing unit (CPU). Also, the processor 1130 may control other components included in the image forming device 1100 such that an operation corresponding to a user input received through a user interface device (not shown) is performed. Furthermore, the processor 1130 may include at least one specialized processor corresponding to each function or may be a single integrated processor.

The processor 1130 may control an operation of the image forming device 1100 such that the first image forming job is performed. In an example, the processor 1130 may perform the first image forming job by controlling at least one configuration or unit used for performing the first image forming job. For example, when the first image forming job is a print job, the processor 1130 in the image forming device 1100 may perform a certain image forming job by controlling a printing unit in the image forming device 1100. As another example, when the first image forming job is a copying job, the processor 1130 in the image forming device 1100 may perform a certain image forming job by controlling a copying unit in the image forming device 1100.

The processor 1130 may generate at least one piece of transaction information including consumption information of at least one consumable in the image forming device 1100, in accordance with the first image forming job.

For example, the consumable may be a toner cartridge, an OPC drum, a roller, or the like. A private key and a public key for the consumable may be used to obtain the transaction information including consumable consumption information. The private key and the public key for the consumable may be stored in an internal storage of the consumable or stored in the memory 1120 of the image forming device 1100.

For example, the image forming device 1100 may obtain first consumption information about a first consumable in the image forming device 1100 according to the first image forming job. The processor 1130 may obtain first identification information indicating the first consumable and generate first transaction information encrypted with the first consumption information. The first identification information may be eigenvalue information of the first consumable.

The first transaction information may further include additional information for tracking use of the first consumable, such as the name of the first consumable, the name of the image forming device 1100 equipped with the first consumable, and the like. The first consumption information may be stored as a value of a certain parameter that is a reference for measuring consumption of a first consumable. For example, the certain parameter may be a driving amount such as the number of revolutions of parts related to the first consumable, information about the number of output pages, dot count information of the output, and the like.

The processor 1130 may generate a first hash value by applying information including first identification information and the first consumption information to a hash function. The hash function is a function for generating unique data when certain data is input. The processor 1130 may encrypt the first hash value with a private key corresponding to the first consumable to generate a digitally signed first ciphertext.

The processor 1130 may transmit at least one piece of transaction information to a plurality of nodes having a ledger, based on the network of the block chain.

For example, the processor 1130 may transmit the first transaction information including the first consumption information of the first consumable in the image forming device 1110 to a plurality of nodes. The plurality of nodes receiving the first transaction information may verify validity of the first transaction information and generate a block including the first transaction information. The generated block may be added to the block chain.

In another example, the processor 1130 may transmit a block in which the first transaction information is recorded to a plurality of nodes through the communication device 1110. In an example, the processor 1130 may record the first transaction information in a candidate block. When a certain number or more of pieces of transaction information are recorded in the candidate block, the processor 1130 may prove a job of the candidate block and add the candidate block to a block chain of the image forming device 1100 as a valid first block. The processor 1130 may transmit the first block to a plurality of nodes through the communication device 1110.

The processor 1130 may obtain first accumulated reference consumption information about a first consumable based on a ledger recorded in the block chain of the image forming device 1100. In an example, the processor 1130 may extract at least one piece of first consumption information of the first consumable from the ledger recorded in the block chain. The processor 1130 may obtain the first accumulated reference consumption information of the first consumable by summing at least one piece of first consumption information of the first consumable.

The processor 1130 may compare the first accumulated consumption information of the first consumable stored in the image forming device 1100 with the first accumulated reference consumption information, according to a certain period. The first accumulated consumption information of the first consumable may be updated each time the first consumable is used.

The processor 1130 may confirm whether the first accumulated consumption information and the first accumulated reference consumption information match. When the first accumulated consumption information matches the first accumulated reference consumption information, the processor 1130 may confirm integrity of the first accumulated reference consumption information. When the first accumulated consumption information and the first accumulated reference consumption information do not match with each other, the processor 1130 may update the first accumulated consumption information of the first consumable with the first accumulated reference consumption information. Since the first accumulated reference consumption information is obtained from the consumption information of the first consumable recorded in the block chain, integrity of the first accumulated reference consumption information may be guaranteed. Therefore, the image forming device 1100 may correct the first accumulated consumption information of the first consumable to the first accumulated reference consumption information.

When the first consumable in the image forming device 1100 is replaced with a second consumable which is substantially the same as the first consumable, the processor 1130 may obtain second accumulated reference consumption information of the second consumable based on the network of the block chain. For example, when the second consumable has been installed in another image forming device, the processor 1130 may obtain transaction information including consumption information of the second consumable based on the network of the block chain. The processor 1130 may obtain the second accumulated reference consumption information of the second consumable based on the transaction information including the consumption information of the second consumable. The processor 1130 may update the second accumulated consumption information of the second consumable with the second accumulated reference consumption information.

In an example, the processor 1130 may request only the transaction information about consumables of the image forming device 1100 to nodes having the block chain. In this case, the processor 1130 may transmit the public key or an identification number of the image forming device 1100 to the nodes through the communication device 1110. Each of the nodes may extract only the transaction information about the image forming device 1100 at the request of the processor 1130.

The processor 1130 may receive only the transaction information about consumables of the image forming device 1100 from the nodes through the communication device 1110.

The processor 1130 may generate a write block that manages only consumable consumption information of the image forming device 1100. Further, the processor 1130 may add the write block to a write block chain.

The above-described method of operating the image forming device may be implemented in the form of a non-transitory computer-readable recording medium storing instructions or data executable by a computer or a processor. The examples may be written as computer programs and may be implemented in general-use digital computers that execute programs using the computer-readable recording medium. The computer-readable recording medium may include read only memory (ROM), random access memory (RAM), flash memory, CD-ROMs, CD-Rs, CD+Rs, CD-DVD-Rs, DVD-Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, or solid-state disks (SSD), and may be any device capable of storing instructions or software, associated data, data files, and data structures, and providing the instructions or software, associated data, data files, and data structures to a processor or a computer such that the processor or computer may execute the instructions.

Although the examples have been described with reference to the accompanying drawings, those of ordinary skill in the art will understand that various changes and modifications may be made therein. For example, the relevant results may be achieved even when the described technologies are performed in a different order than the described methods, and/or even when the described components such as systems, structures, devices, and circuits are coupled or combined in a different form than the described methods or are replaced or substituted by other components or equivalents.

Therefore, the scope of the present disclosure should be defined not by the described examples alone, but by the appended claims and the equivalents thereof.

What is claimed is:

1. A method of operating an image forming device, the method comprising:
performing a first image forming job in the image forming device;
generating at least one piece of transaction information comprising consumption information of at least one consumable in the image forming device, in accordance with the first image forming job; and
based on a network of a block chain that distributes and manages ledgers on which consumption information of consumables in a plurality of image forming devices is recorded, transmitting the at least one piece of transaction information to a plurality of nodes having the ledgers.

2. The method of claim 1, wherein the generating of the at least one piece of transaction information comprises:
obtaining first consumption information about a first consumable in the image forming device according to the first image forming job;
generating first identification information indicating the first consumable: and
generating first transaction information encrypted with the first consumption information.

3. The method of claim 2, wherein the generating of the at least one piece of transaction information comprises:
generating a first hash value by applying information comprising the first identification information and the first consumption information to a hash function; and
encrypting the first hash value with a private key corresponding to the first consumable to generate a first ciphertext.

4. The method of claim 2, wherein the transmitting of the at least one piece of transaction information to the plurality of nodes comprises:
transmitting the first transaction information comprising the first consumption information about a first consumable in the image forming device or a block in which the first transaction information is recorded to the plurality of nodes.

5. The method of claim 4, wherein the transmitting of the block in which the first transaction information is recorded to the plurality of nodes comprises:
recording the first transaction information in a candidate block;
when a certain number or more of pieces of transaction information are recorded in the candidate block, proving a job of the candidate block and adding the candidate block to the block chain of the image forming device as a valid first block; and
transmitting the first block to the plurality of nodes.

6. The method of claim 5, wherein the block chain of the image forming device is configured to manage a ledger on which consumption information of only a consumable installed in the image forming device is recorded.

7. The method of claim 1, further comprising:
receiving a second block in which a job proof is completed from a second node on the network of the block chain to confirm validity of at least one piece of transaction information included in the second block and validity of a block header of the second block, and verifying validity of the second block;
when the second block is valid, adding the second block to the block chain of the image forming device; and
when the second block is invalid, discarding the second block and generating a valid block to be added to the image forming device.

8. The method of claim 1, further comprising:
updating accumulated consumption information of the at least one consumable in the image forming device every time a certain image forming job is performed in the image forming device;
comparing the accumulated consumption information with the ledger recorded in the block chain of the image forming device; and
verifying consumption information of each of the at least one consumable based on a result of the comparing.

9. The method of claim 8, wherein the verifying of the consumption information of each of the at least one consumable comprises:
based on at least one piece of first consumption information about a first consumable extracted from the ledger recorded in the block chain of the image forming device, obtaining first accumulated reference consumption information of the first consumable;
comparing the first accumulated consumption information of the first consumable stored in the image forming device with the first accumulated reference consumption information, according to a certain period; and
when the first accumulated consumption information and the first accumulated reference consumption information do not match each other, updating the first accumulated consumption information of the first consumable with the first accumulated reference consumption information.

10. The method of claim 9, further comprising:
when the first consumable in the image forming device is replaced with a second consumable which is the same as the first consumable, obtaining second accumulated reference consumption information of the second consumable based on the network of the block chain; and
updating second accumulated consumption information of the second consumable with the second accumulated reference consumption information.

11. A non-transitory computer-readable storage medium having recorded thereon instructions executable by a processor, the non-transitory computer-readable storage medium comprising:
instructions to perform a first image forming job in an image forming device;
instructions to generate at least one piece of transaction information comprising consumption information of at least one consumable in the image forming device, in accordance with the first image forming job; and
based on a network of a block chain that distributes and manages ledgers on which consumption information of consumables in a plurality of image forming devices is recorded, instructions to transmit the at least one piece of transaction information to a plurality of nodes having the ledgers.

12. An image forming device comprising:
a communication device;
a processor; and
a memory to store instructions executable by the processor,
wherein the processor executes the instructions to:
control a first image forming job to be performed in an image forming device,
generate at least one piece of transaction information comprising consumption information of at least one consumable in the image forming device, in accordance with the first image forming job, and
based on a network of a block chain that distributes and manages ledgers on which consumption information of consumables in a plurality of image forming devices is recorded, transmit the at least one piece of transaction information to a plurality of nodes having the ledgers.

13. The image forming device of claim 12, wherein the processor executes the instructions to:
obtain first consumption information about a first consumable in the image forming device according to the first image forming job,
generate first identification information indicating the first consumable, and
generate first transaction information encrypted with the first consumption information.

14. The image forming device of claim 12, wherein the processor executes the instructions to:
record first transaction information comprising first consumption information about a first consumable in the image forming device in a candidate block,
when a certain number or more of pieces of transaction information are recorded in the candidate block, prove a job of the candidate block and add the candidate block to the block chain of the image forming device as a valid first block, and
transmit the first block to the plurality of nodes through the communication device.

15. The image forming device of claim 12, wherein the processor executes the instructions to:
update accumulated consumption information of the at least one consumable in the image forming device every time a certain image forming job is performed in the image forming device,
compare the accumulated consumption information with the ledgers recorded in the block chain of the image forming device, and
verify consumption information of each of the at least one consumable based on a result of the comparing.
